(19) United States
(12) Patent Application Publication
(10) Pub. No.: US 2026/0320369 A1
(43) Pub. Date: Oct. 15, 2026

(54) SCALABLE TENSORIZED OPTICAL NEURAL NETWORK ARCHITECTURE

(71) Applicant: THE REGENTS OF THE UNIVERSITY OF CALIFORNIA, Oakland, CA (US)

(72) Inventors: Xian Xiao, Davis, CA (US); Sung-Joo Ben Yoo, Davis, CA (US)

(73) Assignee: THE REGENTS OF THE UNIVERSITY OF CALIFORNIA, Oakland, CA (US)

(21) Appl. No.: 19/195,192

(22) Filed: Apr. 30, 2025

Related U.S. Application Data
(63) Continuation of application No. PCT/US2023/081097, filed on Nov. 27, 2023.
(60) Provisional application No. 63/385,381, filed on Nov. 29, 2022.

(51) Int. Cl. G06N 3/067; G06N 3/042

(52) U.S. Cl. CPC G06N 3/0675; G06N 3/042

(57) ABSTRACT

A large-scale, energy-efficient, high-throughput, and compact tensorized optical neural network (TONN) exploiting the tensor-train decomposition architecture on an integrated III-V-on-silicon metal-oxide-semiconductor capacitor (MOSCAP) platform. The TONN architecture is scalable to 1024×1024 synapses and beyond, which is extremely difficult for conventional integrated ONN architectures by using cascaded multi-wavelength small-radix (e.g., 8×8) tensor cores.

### CROSS-REFERENCE TO RELATED APPLICATIONS

This application claims priority to, and is a 35 U.S.C. § 111 (a) continuation of, PCT international application number PCT/US2023/081097 filed on Nov. 27, 2023, incorporated herein by reference in its entirety, which claims priority to, and the benefit of, U.S. provisional patent application Ser. No. 63/385,381 filed on Nov. 29, 2022, incorporated herein by reference in its entirety. Priority is claimed to each of the foregoing applications.

The above-referenced PCT international application was published as PCT International Publication No. WO 2024/118474 A1 on Jun. 6, 2024, which publication is incorporated herein by reference in its entirety.

### STATEMENT REGARDING FEDERALLY SPONSORED RESEARCH OR DEVELOPMENT

This invention was made with Government support under FA9550-18-1-0186, awarded by the United States Air Force Office of Scientific Research (AFOSR). The Government has certain rights in the invention.

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

Artificial neural networks (ANNs) have proven remarkable capabilities in various tasks, including computer vision, speech recognition, machine translations, medical diagnoses, and the game of Go. Neuromorphic computing accelerators, such as IBM TrueNorth and Intel Loihi, have shown significantly superior performance compared with traditional central processing units (CPUs) for specific neural network tasks. A majority of the electrical ANN hardware's energy consumption comes from data movement in the synaptic interconnections.

Optical neural networks (ONNs), also known as photonic neural networks, are expected to improve the energy efficiency and throughput significantly compared with electrical ANNs due to the capabilities of transmitting data at the speed of light without having a length-dependent impedance. However, there are mainly two challenges that prevent ONNs from achieving competitive performance with the electrical ANNs.

The first challenge is the limited scalability. While electrical ANN hardware is capable of achieving 4096 synaptic connections per neuron, the scale of the state-of-the-art ONNs is limited to 64×64 or smaller. This is because the synaptic interconnections in conventional ONNs typically rely on Mach-Zehnder interferometer (MZI) meshes. Scaling up to high-radix N×N meshes requires O(N²) MZIs and O(N) cascaded stages, which lead to insurmountable footprint, optical loss budget, and control complexity.

For example, Lightmatter's Mars device integrates a 64×64 micro-electro-mechanical systems (MEMS) MZI mesh on a 150 mm² chip. With the same architecture and device platform, the predicted chip size for 1024×1024 will be larger than an 8-inch wafer and the optical insertion loss of 1024 cascaded stages of MEMS MZIs will be >675 dB, which is tough to be compensated by using optical amplifiers. The limited scalability makes the conventional ONNs typically rely on pre-processing and convolutional layers to handle meaningful machine learning (ML) datasets (e.g., ImageNet datasets).

However, the convolutional neural networks (CNNs) are only efficient for specific tasks (e.g., image classification and time series) and require many layers. On the other hand, some literature proposes to pursue large-scale ONNs with comparable scale as the electrical ANN hardware. However, these efforts retain the conventional ONN architecture or reduce the throughput by encoding the input data in time domain or require bulky free-space devices.

The second challenge of ONNs is the lack of a device platform that can monolithically integrate optical neurons with photodetectors (PDs), electrical neuron circuits, light emitters, and synaptic interconnections on silicon. By sharing the same fabrication process steps in most parts as the silicon complementary metal-oxide-semiconductor (CMOS) process, silicon photonics (SiPh) has been proved to be a desirable platform for the commercial large-volume and cheap electronic and photonic integrated circuit (EPIC) manufacturing. However, since silicon is an indirect bandgap material, the silicon light emitters are inefficient. Aligning III-V diode laser chips to SiPh chips will induce additional coupling losses and packaging complexity, limiting energy efficiency and integration density.

The method disclosed in this application provides a solution of using a tensorized ONN (TONN) architecture in order to address and mitigate these two challenges of ONNs.

### BRIEF SUMMARY

This disclosure describes a large-scale, energy-efficient, high-throughput, and compact tensorized optical neural network (TONN) exploiting the tensor-train decomposition architecture on an integrated III-V-on-silicon metal-oxide-semiconductor capacitor (MOSCAP) platform. The TONN architecture is scalable to 1024×1024 synapses and beyond, which is extremely difficult for conventional integrated ONN architectures by using cascaded multi-wavelength small-radix (e.g., 8×8) tensor cores. Simulation experiments show that the TONN uses 79× fewer Mach-Zehnder interferometers (MZIs) and 5.2× fewer cascaded stages of MZIs compared with the conventional ONN while maintaining a >95% training accuracy for Modified National Institute of Standards and Technology handwritten digit classification tasks. Furthermore, with the proven heterogeneous III-V-on-silicon MOSCAP platform, the TONN can improve the footprint-energy efficiency by a factor of 1.4×10⁴ compared with digital electronics artificial neural network (ANN) hardware and a factor of 2.9×10² compared with silicon photonic and phase-change material technologies.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE DRAWINGS

The technology described herein will be more fully understood by reference to the following drawings which are for illustrative purposes only:

FIG. 1 is an example illustration of a schematic of an ONN architecture including input layers, hidden layers, output layers, and synaptic interconnections.

FIG. 2 is an example illustration of an ONN Weight Matrix (W) undergoing TT decomposition for parameter compression.

FIG. 3A is an example illustration of a schematic of the products between the input data and the TT-cores in sequence.

FIG. 3B is an example illustration of a unitary matrix represented by a rectangular MZI mesh according to various embodiments of the present disclosure.

FIG. 3C is an example illustration of a 2×2 MZI as the building block of rectangular MZI meshes according to various embodiments of the present disclosure.

FIG. 4 is an example illustration of a M×N TONN architecture with a single wavelength.

FIG. 5A is an example illustration of a M×N TONN architecture with multiple wavelengths according to various embodiments of the present disclosure.

FIG. 5B is an example illustration of a M×N TONN architecture with multiple wavelengths according to various embodiments of the present disclosure.

FIG. 6 is an example illustration of graphs showing the comparison of the total number of MZIs and cascaded stages of MZI between conventional ONN and TONN-MW according to various embodiments of the present disclosure. The yellow stars represent the current state-of-the-art 64×64 conventional ONN.

FIG. 7 is an example illustration of graphs showing the comparison of test accuracy of conventional ONN, TONN-MW, and FT-ONN based on the total number of MZIs and cascaded stages used, according to various embodiments of the present disclosure.

FIG. 8A-8C together are an example illustration of a device architecture of a 1024×1024 TONN-MW according to various embodiments of the present disclosure.

FIG. 9A is an example illustration of a schematic of the quantum dot (QD) comb laser and MOSCAP microring modulator with a MOSCAP transmission electronic microscopy (TEM) image.

FIG. 9B is an example illustration of a graph showing the optical spectrum of the QD comb laser according to various embodiments of the present disclosure.

FIG. 9C is an example illustration of a schematic of a high-responsivity Si—Ge waveguide APD enhanced by loop reflectors.

FIG. 9D is an example illustration of a graph showing the results of the experimental demonstration of a MOSCAP microring modulator spectra according to various embodiments of the present disclosure.

FIG. 10 is an example computing component that includes one or more hardware processors and machine-readable storage media storing a set of machine-readable/machine-executable instructions that, when executed, cause the one or more hardware processors to perform an illustrative method for implementing a tensorized optical neural network according to various embodiments of the present disclosure.

FIG. 11 illustrates a block diagram of an example computer system in which various embodiments of the present disclosure may be implemented.

### DETAILED DESCRIPTION

Described herein is a large-scale, energy-efficient, high-throughput, and compact tensorized ONN (TONN) architecture that may be incorporated on a densely integrated III-V-on-silicon metal-oxide-semiconductor capacitor (MOSCAP) platform. On the architecture side, tensor-train (TT) decomposed synaptic interconnections may be used to realize large-scale ONNs with reduced hardware resources. In addition, the applications of TT-decomposed optical synaptic interconnections described herein are not limited to ONNs, but also potentially any optical computing systems that require fully connected layers.

As an effective approach to significantly compress the over-parameterized fully connected layers in ANNs, TT decomposition has been proved to not only achieve almost the same accuracy as an ensemble of deep CNNs on various tasks, including the Markov random field, image recognition, and video classification, but TT decomposition is also able to achieve the same accuracy using a smaller number of parameters. On the device platform side, although tensorized ONN (TONN) can be implemented in various photonic platforms, heterogeneous III-V-on-silicon integration is an optimal choice. Integration of quantum dot (QD) comb lasers and avalanche photodiodes (APDs) with other SiPh devices at wafer scale further improves the energy efficiency of the TONN.

The TT decomposition enables the TONN architecture to be scalable to 1024×1024 and beyond, which is extremely difficult for conventional integrated ONNs. Photonic components in typical ONNs are typically physically large in size and require a large amount of memory to store the data being processed. Even the physical implementation of tensorized neural networks usually requires memory between each adjacent TT-core to store the intermediate data. Provided here is a ‘memory-free’ TONN architecture.

The detailed device architecture of the TONN is designed based on a multi-wavelength configuration that does not require intermediate memory. The TONN design also requires less components to process such photonic input signals which allows a TONN to be designed at a much smaller physical scale. In addition, the use of TT-layers in a TONN adds more usefulness in the processing and analysis of photonic input signals over typical ONNs as all of the weight matrix (W) operations may be performed in parallel, allowing for faster processing.

Simulations show that the TONNs utilize 79× fewer number of MZIs and 5.2× fewer cascaded stages of MZIs than the conventional ONNs while maintaining a >95% accuracy for Modified National Institute of Standards and Technology (MNIST) handwritten digit classification tasks. Moreover, the monolithic III-V-on-silicon MOSCAP platform provides MOSCAP synaptic MZIs with negligible static phase tuning energy consumption, a photodetector-free hitless monitoring scheme to reduce more than O(N₂) control elements and pads, and dense wavelength division multiplexing (DWDM)-based neurons. With all the experimentally proven building blocks, the footprint-energy efficiency [(MAC/J)(MAC/s/mm²)] of the TONNs can be further improved by a factor of 2.9×10² compared with other photonic platforms and a factor of 1.4×10⁴ compared with the state-of-the-art digital electronic ANNs.

### Tensorized Optical Neural Network: Principle of Tensor-Train Decomposition.

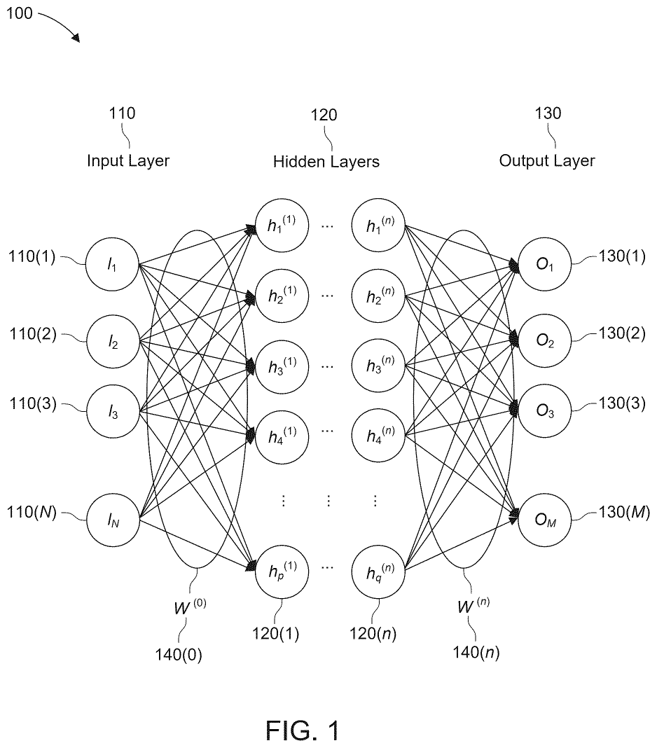

ONNs, such as ONN 100, typically consist of an input neuron layer 110, many hidden neuron layers 120, an output neuron layer 130, and synaptic interconnections, which can be abstracted by arbitrary weight matrices (W) 140, as shown in FIG. 1. The more hidden neuron layers present in an ONN, the greater the performance and accuracy that the ONN can achieve. By utilizing singular value decomposition (SVD), the arbitrary weight matrix W can be decomposed into two arbitrary unitary matrices and an array of additional phase shifters and amplitude modulators: W=UΣV.

In ONNs, the arbitrary unitary matrices U and V are typically realized by “loss-less” MZI meshes in a “rectangular” or “triangular” configuration. Each 2×2 MZI contains two phase shifters and two 50/50 optical power splitters. As a result, an N×N MZI mesh requires N(N−1)/2 MZIs and N cascaded stages, making scalability of ONNs limited. Although MEMS or non-volatile technologies can be used to reduce the length of the phase shifters to tens of microns, the MZI meshes are still difficult to scale up to the high radix.

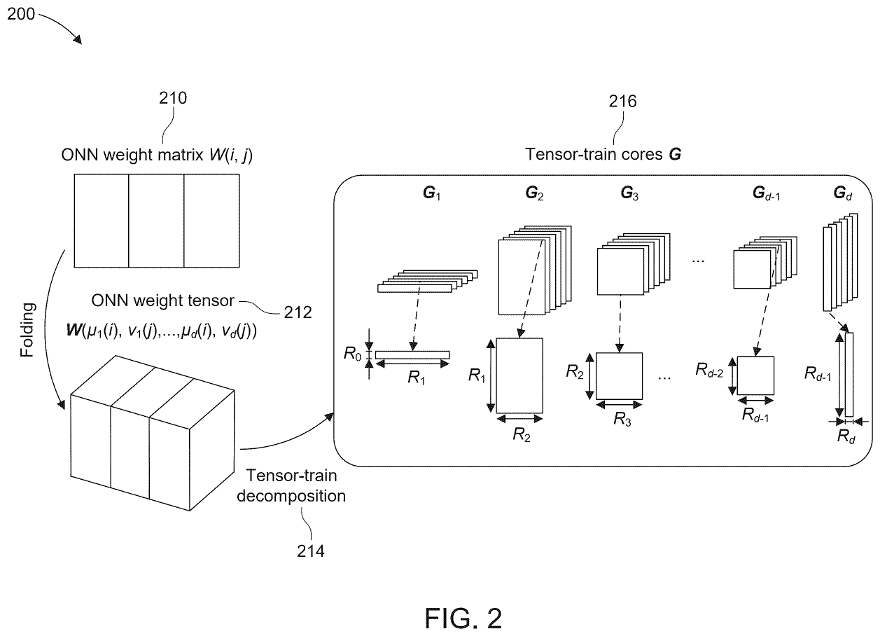

Here, italic lowercase letters, italic uppercase letters, and bold italic uppercase letters are used to represent vectors, matrices, and tensors, respectively. As shown in FIG. 2, to represent weight matrix 210 of Wε [symbol] ^{M×N} in the TT format, the matrix dimensions M and Nare first assumed to be factored as M=Π^{d}ₖ₌₁Mₖ and N=Π^{d}ₖ₌₁Nₖ, where d may be defined as the number factors of M and N. The number factors of M and N can be any combination of numbers. Variables μ and v may be the natural bijections from indices (i,j) of weight matrix 210 (W) to indices [μ₁(i), v₁(i), . . . , μ_{d}(i), v_{d}(j)] of an order-2d weight tensor 212. Then, W(i, j)=W(μ₁ (i), v_{d}(i), . . . , μ_{d}(i), v_{d}(j)). TT decomposition 214 can be interpreted as SVD of multi-dimensional matrices. The TT decomposition 214 may express the tensor Was a series of tensor products, as shown in equation (1) below, where the four-way tensor Gₖ∈ [symbol] ^{R}ₖ₋₁×Mₖ×Nₖ×Rₖ is the TT-core 216 and the total number of tensor cores is d. The vector (R₀, R₁, . . . , R_{d}) is the TT-rank, and R₀=R_{d}=1. In this way, the total number of parameters can be reduced from M×N into the summation of the parameters of each small TT-cores, i.e., Σ_{dk=1}Rₖ₋₁MₖNₖRₖ.

$$W ( {μ}_{1} ( i ) , {γ}_{1} ( j ) , … , {μ}_{d} ( i ) , {γ}_{d} ( j ) = {\prod }_{k = 1}^{d} {G}_{k} ( : , {μ}_{k} ( i ) , {γ}_{k} ( j ) , : ) \qquad ( 1 )$$

### Tensorized Optical Neural Network: Tensor-Train Rank Determination.

The choice of TT-ranks influences both the training accuracy and the complexity of the TONN. Smaller TT-ranks usually lead to lower training accuracy, and higher TT-ranks lead to higher computing and storage complexity. TT-rank determination is a nondeterministic polynomial time (NP)-hard problem. Traditional methods require tuning the rank manually, which often leads to suboptimal results as different TT-layers may require different TT-ranks. As an example, a heuristic binary search method may be used to find the smallest TT-ranks for some predetermined accuracy threshold. As another example, some heuristic binary search methods may be used to guide the selection of TT-ranks. As another example, a Bayesian method may be used to optimize the TT-ranks along with the model parameters. Alternatively, the TT-ranks may be determined based on empirical figures.

### Device Architecture of Tensorized Optical Neural Network: Tensor-Train Layers.

To achieve the tensor-train layers 200, as shown in FIG. 2, the tensor x and tensor y=Wx representing the input 310 and output 314, respectively, of the weight matrix W may be reshaped into the tensor format by x(j)=x(μ₁(j), . . . , μ_{d}(j) and y(i)=y(v₁(i), . . . , v_{d}(i), where x∈ [symbol] ^{N}, y∈ [symbol] ^{M}, x∈ [symbol] ^{N}_{d}^{× . . . ×N}₁, and Y∈ [symbol] ^{M}_{d}^{× . . . ×M}₁. Then, in TT format, the linear transformation by the weight tensor W can be represented by equation (2) of

$$y ( {v}_{1} ( i ) , … , {v}_{d} ( i ) ) = {\prod }_{k = 1}^{d} {G}_{k} ( : , {μ}_{k} ( i ) , {v}_{k} ( j ) , : ) x ( {μ}_{1} , ( j ) , … , {μ}_{d} ( j ) ) \qquad ( 2 )$$

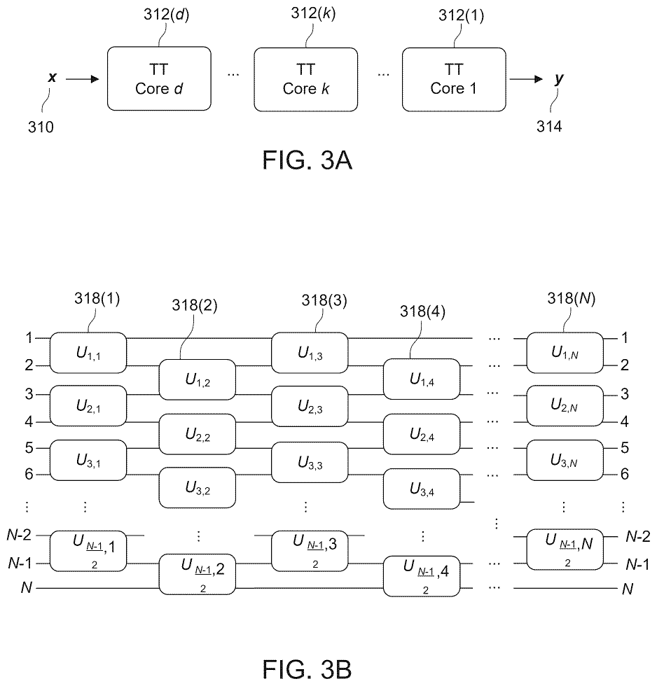

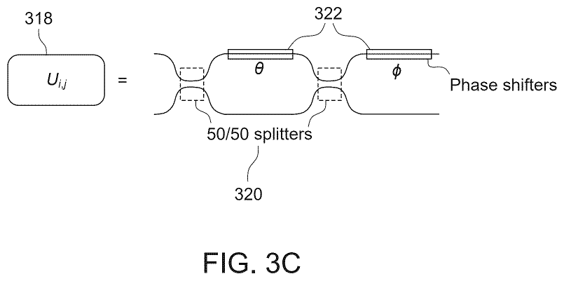

Based on the above equation, input 310 of tensor x needs to be multiplied by each TT-core 312 in the sequence of G_{d}, G_{d-1}, . . . , G₁, as shown in FIG. 3A. The term Iⱼ is used to notate the intermediate tensor: I₁=G_{d}x, I₂=G_{d-1}I₁, . . . , y=I_{d}=G₁I_{d-1}. Then, at TT-core 312 of k, the equation (3) of I_{d-k+1}=GₖI_{d-k}, where k=1, 2, . . . , d, may be obtained. Equation (3) can be physically implemented by a two-step operation. First, Gₖ∈ [symbol] ^{R}ₖ₋₁×^{M}ₖ×^{N}ₖ×^{R}ₖ multiplies by I_{d-K}∈ [symbol] ^{R}ₖ×^{N}ₖ×^{M}_{d}× . . . ×^{M}ₖ₊₁×^{N}ₖ₋₁× . . . ×^{N}₁ and gives GₖI_{d-k}∈ [symbol] ^{R}ₖ₋₁×^{N}ₖ×^{M}_{d}× . . . ×^{M}ₖ₊₁×^{N}ₖ₋₁× . . . ×^{N}₁. Second, GₖI_{d-k} is re-indexed to I_{d-k+1}∈ [symbol] ^{R}ₖ₋₁×^{N}ₖ₋₁×^{M}_{d}× . . . ×^{M}ₖ×^{N}ₖ₋₂× . . . ×^{N}₁ so that each TT layer is modular.

The physical implementation of TT-layers usually requires memory between each adjacent TT-core to store the intermediate data. Here, two “memory-free” device architectures of TONN are disclosed with cascaded photonic TT-cores consisting of small-radix MZI meshes and passive cross-connects. In other words, instead of using a large-scale MZI mesh as shown in FIG. 3B, the large-scale weight matrix (W) is realized by cascading a series of small-scale tensor cores (small-scale MZI meshes), and adding parallelism in the wavelength domain using wavelength division multiplexing (WDM) technology.

### Device Architecture of Tensorized Optical Neural Network: Single-Wavelength Implementation.

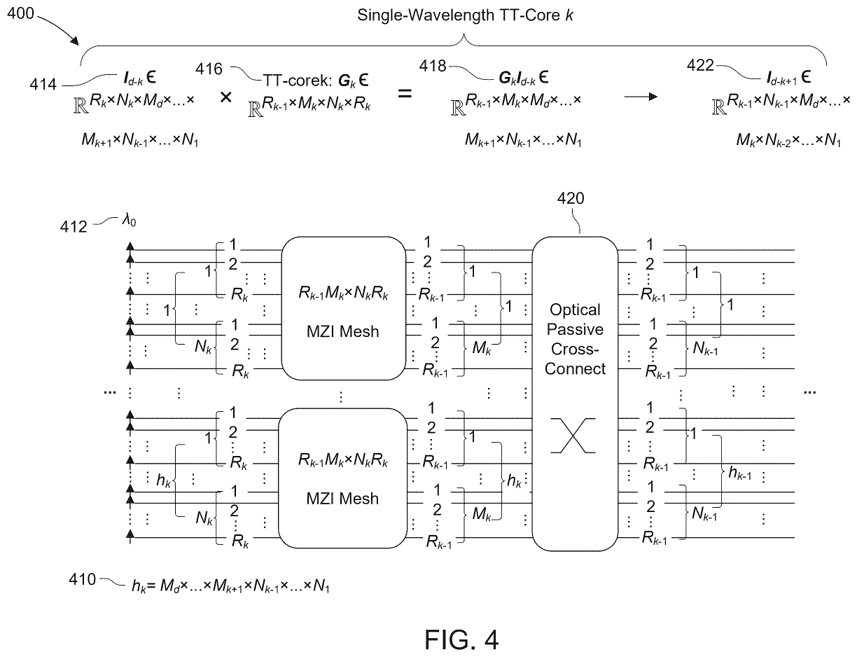

To emulate the tensor product at the TT layer, the first approach may be the TONN with single wavelength (TONN-SW) 400, as shown in FIG. 4. At the TT-core k, where k=d, . . . , 1, the input tensor 414 of I_{d-k} may be represented by variable 410 of hₖ groups of NₖRₖ optical signals at wavelength 412 of λ₀, where variable 410 of hₖ=M_{d}, . . . , Mₖ₊₁Nₖ₋₁, . . . , N₁. The TT-core 416 of Gₖ may be represented by hₖ identical Rₖ₋₁Mₖ×NₖRₖ MZI meshes being put side-by-side. The MZI meshes can be enabled by putting 2×2 MZIs 318 in a “rectangular” mesh, as shown in FIG. 3B. Each 2×2 MZI 318 contains two phase shifters 322 and two 50/50 optical power splitters 320, as shown in FIG. 3C. By sending the input optical signals into the MZI meshes, the product between TT-core 416 of Gₖ and input 414 of I_{d-k} may be implemented and then an optical passive cross-connect 420 may be used for switching the indices of Mₖ and Nₖ₋₁ in the output tensor 418 of GₖI_{d-k} to generate output 422. The output 422 of the cross-connect 420 is I_{d-k+1}, which may then be the input of the next TT layer.

### Device Architecture of Tensorized Optical Neural Network: Multi-Wavelength Implementation.

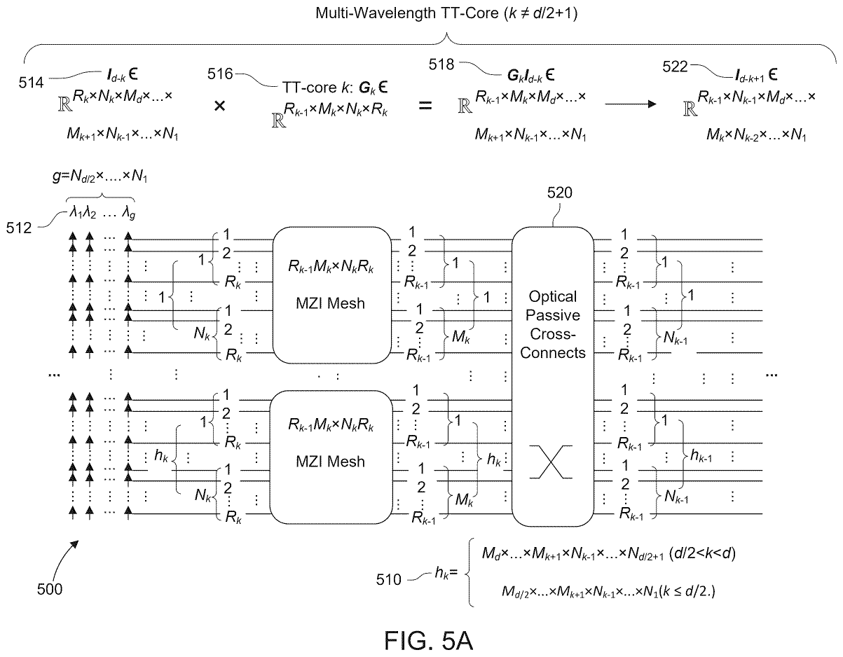

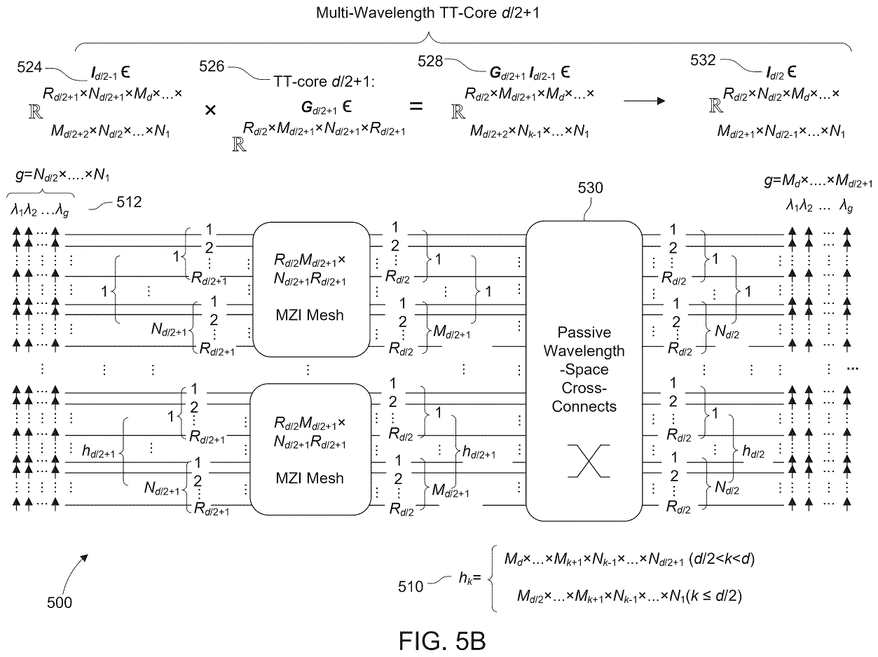

By adding parallelism in the wavelength domain using wavelength division multiplexing (WDM) technology, the TONN with multiple wavelengths (TONN-MWs) 500 can save a considerable amount of MZIs compared with TONN-SW 400, as shown in FIG. 5A and FIG. 5B. In FIG. 5A, at the TT-core 516 of TT-core k, the input tensor 514 of I_{d-k} may be first encoded with the WDM channels 512 of λ₁, λ₂, . . . , λ_{g}, where g=N_{d/2}, . . . , N₁. For the first half of the TT-cores 516 G_{d}, . . . , G_{d2+1}, only the indices of N_{d}, . . . , N_{d/2+1} of the input data x are used for multiplication with the TT-cores 516. Similar to TONN-SW 400, hₖ groups 510 of NₖRₖ g-wavelength WDM signals may first go through hₖ identical Rₖ₋₁Mₖ×NₖRₖ MZI meshes. Here, hₖ=M_{d}, . . . , Mₖ₊₁Nₖ₋₁, . . . , N_{d/2+1} for d/2<k<d or M_{d/2}, . . . , Mₖ₊₁Nₖ₋₁, . . . , N₁ for k≤d/2. Then, for k≠d/2+1, an optical passive cross-connect 520 may be used to switch the indices of Mₖ and Nₖ₋₁ in the output tensor 518 GₖI_{d-k} and gives output 522 of I_{d-k+1}.

In FIG. 5B, at TT-core 526 of TT-core [d/2+1], the output 528 of the MZI meshes G_{d/2+1}I_{d/2-1} may utilize passive wavelength-space cross-connects 530 to switch the indices between the wavelength domain (N_{d/2}, . . . , N₁) and the space domain (M_{d}, . . . , M_{d/2+1}). The wavelength-space cross-connects 530, which can be realized by using WDM transponders, are fixed (no reconfiguration needed) once the TONN architecture is decided. As a result, the output 532 of I_{d/2}∈ [symbol] ^{R}_{d/2}^{l×N}_{d/2}^{×M}_{d}^{× . . . ×M}_{d/2+1}^{×N}_{d/2-1}^{× . . . ×N}₁ may be represented by h_{d/2} groups of N_{d/2}R_{d/2} g-wavelength WDM signals, where variable 534 of g=M_{d}, . . . , M_{d/2+1}. In this way, for the second half of the TT-cores G_{d/2}, . . . , G₁, the indices of N_{d/2}, . . . , N₁ of the input data x can be used for multiplication with the TT-cores. Note that, here, d is assumed to be an even number. When d is an odd number, the wavelength-space cross-connects 530 happens at the TT-core [(d+1)/2].

### Comparison Between Tensorized and Conventional ONNs.

To evaluate the scalability of the TONN, TABLE 1 compares the total number of MZIs and the total number of cascaded stages of MZIs, among conventional ONN, TONN-SW, and TONN-MW. Letting M=N, M₁= . . . =M_{d}=N₁= . . . =N_{d}=N^{1/d}, and R₀= . . . =R_{d}=R, both TONN-SW and TONN-MW can reduce the total number of cascaded stages from N to dRN^{1/d}, compared with the conventional ONN. The TONN-SW can enable all-optical tensor core products without optical-to-electrical-to-optical (O/E/O) conversions; however, the saving of the total number of MZIs is not significant. On the other hand, the TONN-MW can reduce the total number of MZIs from N(N−1)/2 to dRN^{1/2}(RN^{1/d}−1) at the expense of only one layer of OEO conversion for the wavelength-space cross-connects in the TT-core [d/2+1].

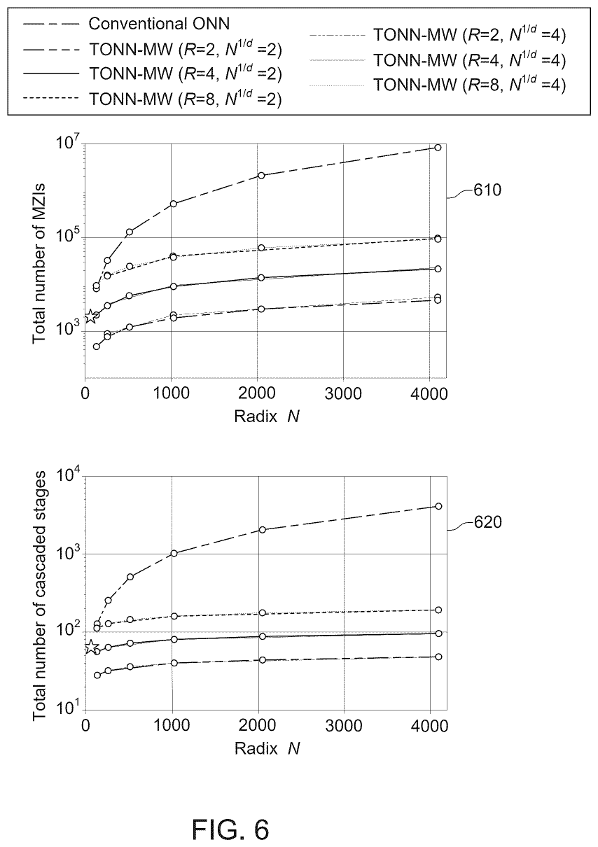

FIG. 6 illustrates graphical representations 610 and 620, that show the comparison of the total number of MZIs and cascaded stages of MZI between conventional ONN and TONN-MW as a function of the radix N where N≥128. For example, at the radix of N=1024, the conventional ONN has 5.2×10⁵ MZIs and 1024 cascaded stages. For R=2 and N₁= . . . =N_{d}=N^{1/d}=2, the TONN-MW requires 40 cascaded stages and 1920 MZIs, which are 25.6× and 272.8× less than the conventional ONN. The stars shown in the graphical representations 610 and 620 represent the current state-of-the-art 64×64 conventional ONN.

### Simulations for Tensorized Optical Neural Networks.

The performance of the TONNs is evaluated by training the MNIST handwritten digit classification tasks and compared with conventional ONNs and two-dimensional Fourier transform (2D-FT) pre-processed ONNs (FT-ONNs). The conventional ONNs have a configuration similar to that of the TONN while having much more parameters (i.e., MZIs) in the synaptic interconnections. As another method to scale ONNs, the FT-ONNs may have a total number of MZIs similar to that of the TONNs but fewer neurons in the input layer due to pre-processing the input images. All the compared ONNs are designed with one input layer, one hidden layer, and one output layer. Each type of ONN includes the following components described below.

Conventional ONNs have 784 neurons in the input layer, a varied number (4-2048) of neurons in the single hidden layer, and ten neurons in the output layer. The input data are the 28×28 grayscale MNIST images.

The TONN-MWs are with 784 neurons in the input layer, 1024 neurons in the hidden layer, and ten neurons in the output layer. The 784×1024 and 1024×10 synaptic interconnections are factorized as [4×7×7×4×4×8×8×4] and [4×8×8×4×1×5×2×1] for TT decomposition, respectively. The TT-ranks vary from 1 to 24.

The 2 FT-ONNs are with 200 neurons in the input layer, a varied number (20-800) of neurons in the hidden layer, and ten neurons in the output layer. The input grayscale MNIST images are first Fourier transformed and then cropped to 20×10. The absolute values of the 200 complex-valued 2D-FT coefficients are used for the input of the FT-ONN.

Training simulations may be performed by using TensorFlow and T3F Python libraries. The backpropagation algorithm may train each ONN with the Adam optimizer in ten epochs. Every neuron may have a rectified linear unit activation function, and the categorical cross-entropy loss may evaluate the network's performance. The synaptic interconnections may be assumed to be ideal (error-free). For each of the three ONNs listed above, 20 different trials with different random initialization may be generated.

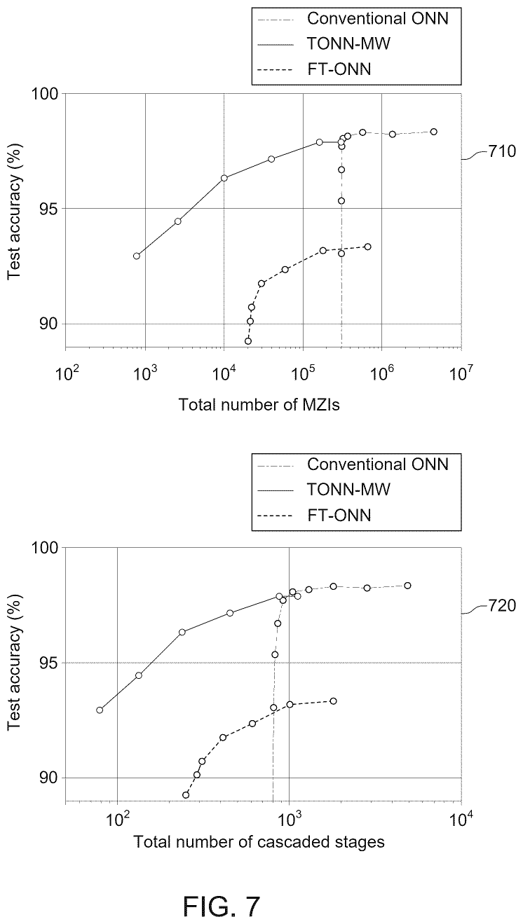

FIG. 7 illustrates graphical representations 710 and 720, that show the comparison of test accuracy of conventional ONN, TONN-MW, and FT-ONN based on the total number of MZIs and cascaded stages used, respectively. Considering that the SVD of an M×N arbitrary matrix gives one M×M and one N×N unitary arbitrary matrix, the total number of MZIs and cascaded stages for an M×N arbitrary weight matrix in the simulation is calculated by M(M−1)/2+N(N−1)/2 and M+N, respectively. To achieve >95% test accuracy, TONN-MW only requires 3890 MZIs and 157 cascaded stages, which are 79× and 5.2× less than the conventional ONN, respectively. With the same total number of MZIs and cascaded stages, TONN-MWs have at least 4.7% higher test accuracy compared with FT-ONNs. A higher test accuracy represents a greater amount of input signals that are being accurately analyzed and processed through an ONN.

### TONN-MW on Heterogeneous III-V-on-Silicon MOSCAP Platform.

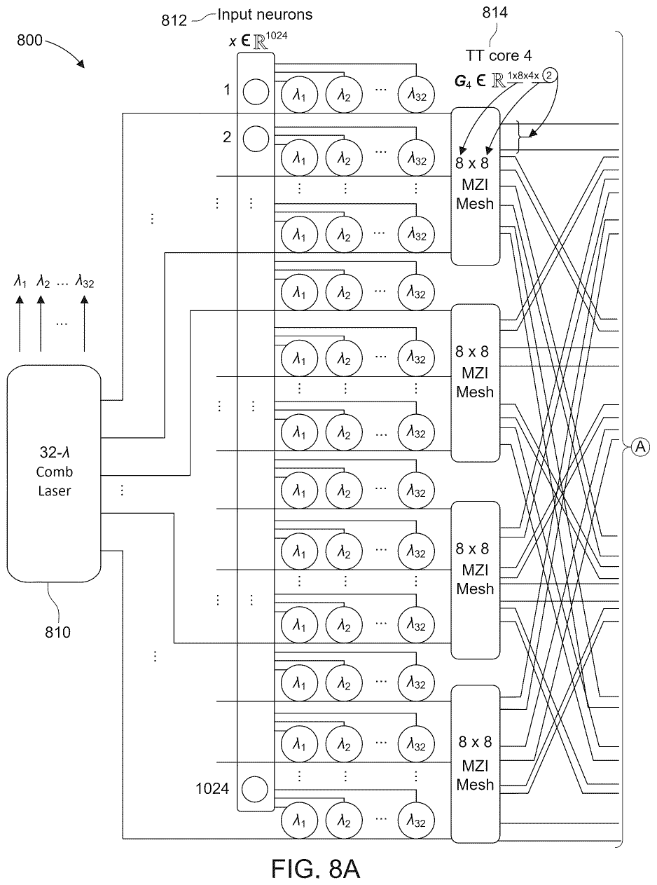

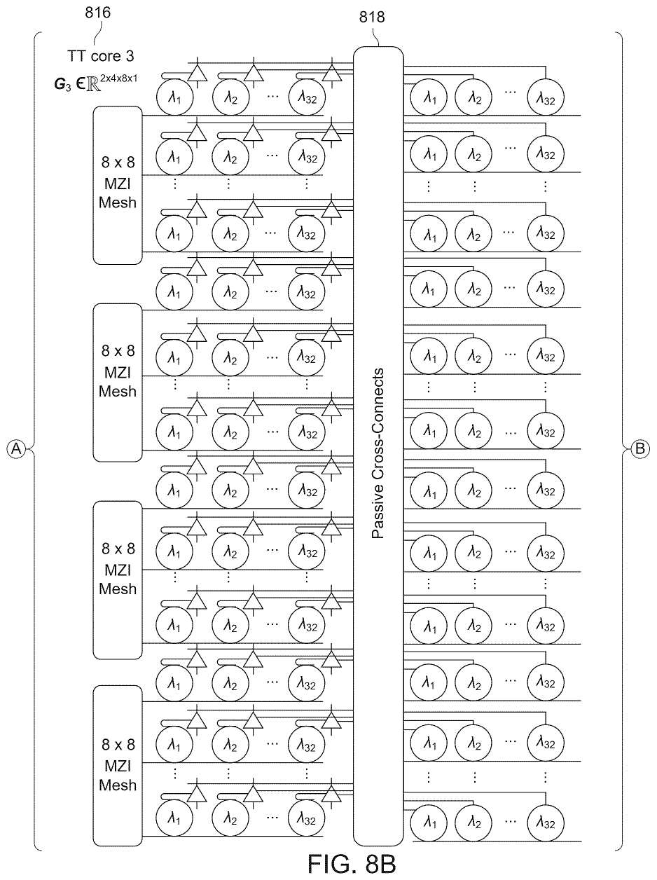

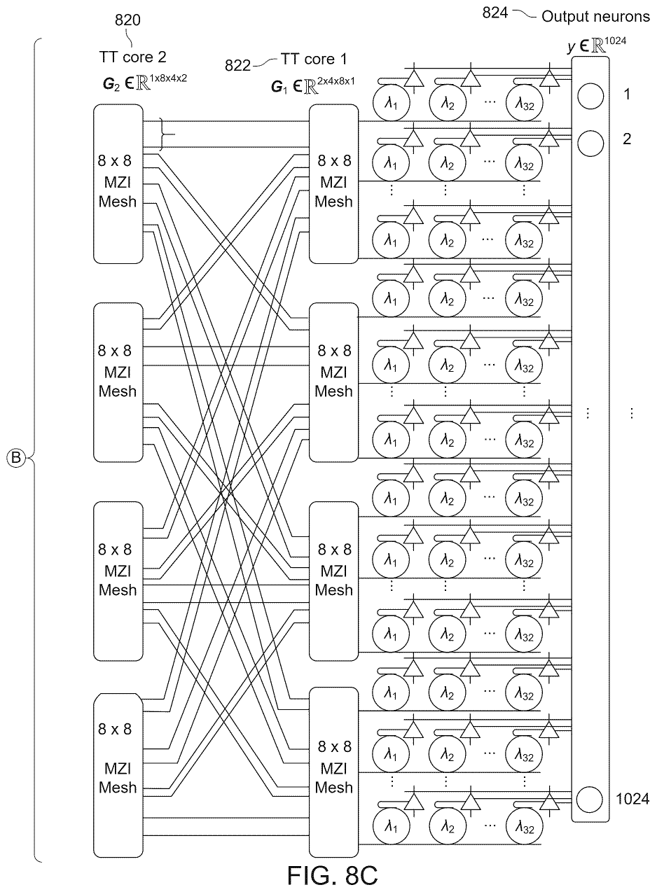

FIG. 8A-8C illustrate an example device architecture 800 of a 1024×1024 TONN-MW. The 1024×1024 TONN-MW is factorized as 8×4×4×8×8×4×4×8. Here, the total number of tensor core layers (d) is four (d=4), and the total number of wavelengths (g) is g=32. The TT-rank is set as R₀=R₄=1 and R₁=R₂=R₃=2. As a result, the weight matrix is decomposed into four tensor cores (TT-cores) with the dimensions of TT-core (4) 814 of G₄∈ [symbol] ^{1×8×4×2}, TT-core (3) 816 of G₃∈ [symbol] ^{2×4×8×1}, TT-core (2) 820 of G₂∈ [symbol] ^{1×8×4×2}, and TT-core (1) 822 of G₁∈ [symbol] ^{2×4×8×1}. Each TT-core contains four 8×8 MZI meshes side-by-side and cross-connects, leading to a total of sixteen 8×8 MZI meshes, 448 MZIs, and 32 cascaded stages of MZIs. The input neuron signals 812 are first modulated by using thirty-two 32-wavelength WDM microring modulator arrays, then multiplied by each TT-core, and finally detected by using thirty-two 32-wavelength WDM microring add-drop filter and detector arrays to generate output neuron signals 824. The light source is provided by a 32-wavelength comb laser 810 and power splitters. O/E/O conversions and passive electrical cross-connects enable the wavelength-space cross-connects 818 at TT-core (3) 816.

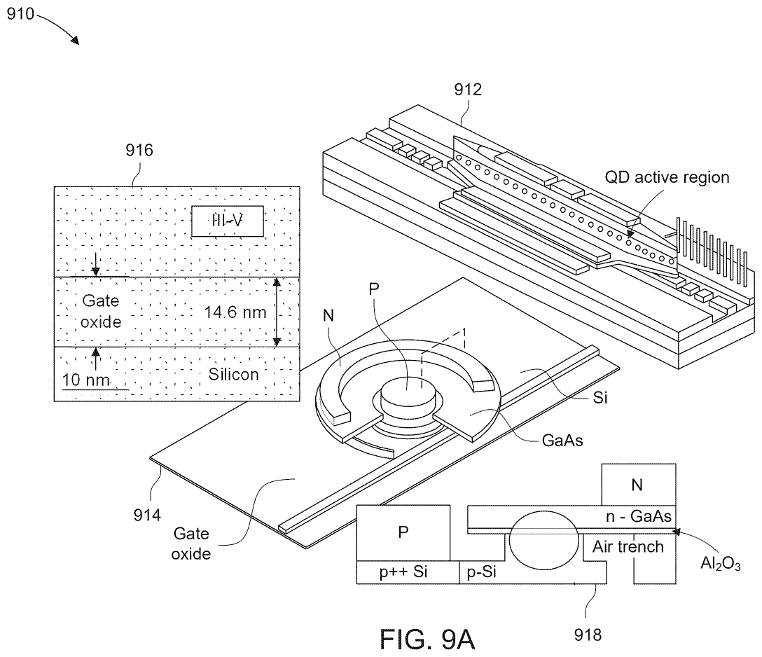

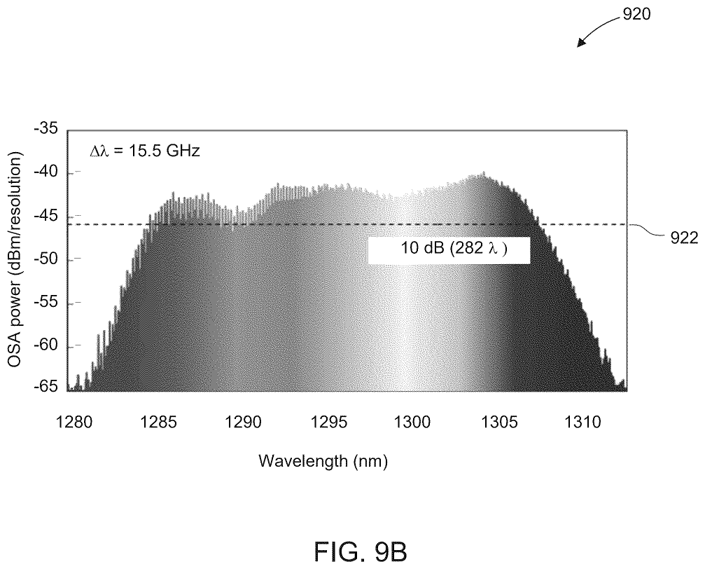

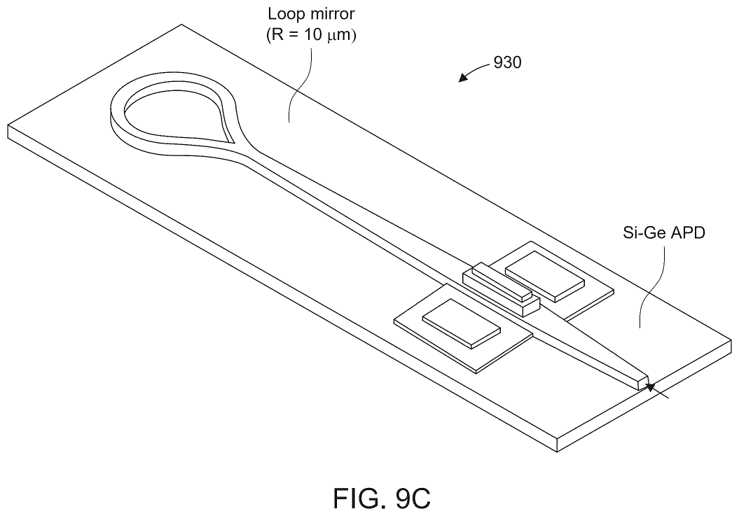

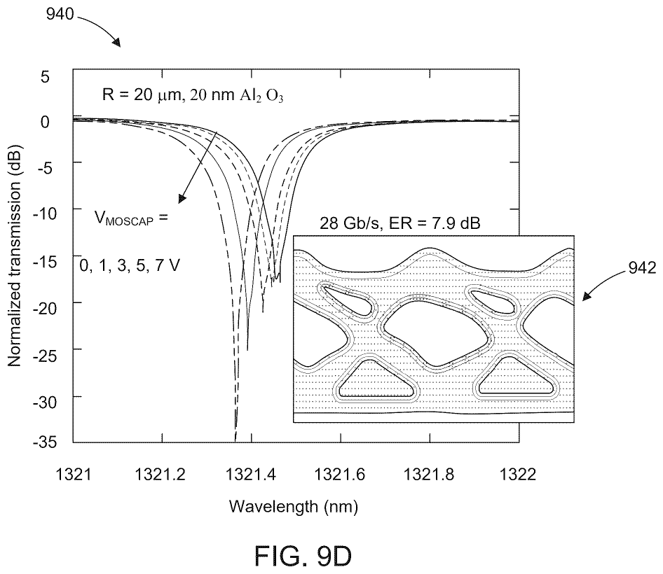

FIGS. 9A-9D illustrate components and graphical representations of the results of the device architecture 800 of a 1024×1024 TONN-MW device architecture illustrated in FIG. 8A-8C. Using a III-V-on-silicon MOSCAP platform is particularly suitable for implementing the TONN-MW since it can heterogeneously integrate all the required devices, including quantum dot (QD) comb lasers, MOSCAP microring modulators, MOSCAP phase shifters (MZIs), and QD or potentially silicon-germanium (Si—Ge) avalanche photodetectors (APDs) at wafer scale. FIGS. 9A-9D thus illustrate that the 1024×1024 TONN-MW device architecture illustrated in FIG. 8A-8C can be created and can provide an improvement in results compared to other ONN schematics.

FIG. 9A illustrates a schematic 910 of the quantum dot (QD) comb laser 912 and MOSCAP microring modulator 914 with a MOSCAP cross-section structure image 916, which is a representative image of the QD active region of the QD comb laser 912. The QD active region represents a single QD layer of QDs that are a few nanometers in size. Image 918 illustrates the layout of the components that are included in the MOSCAP microring modulator 914.

FIG. 9B illustrates a graph representation 920 showing the optical spectrum of the QD comb laser 912 at various wavelengths, measured in nm. The graph representation 920 further illustrates, using dotted line 922, that the QD comb laser 912 has a record wide 10-dB comb width of 25 nanometers (nm). This represents that one laser can accommodate more than 280 wavelengths with 15.5 GHz spacing. Therefore, it is feasible to realize the 32-wavelength stream for the 1024×1024 TONN-MW as illustrated in FIG. 8A-8C.

FIG. 9C illustrates a schematic 930 of a high-responsivity Si—Ge waveguide APD enhanced by loop reflectors. SiGe APDs may offer exceptional sensitivities, including −30 dBm, at particular speeds. The low sensitivities at particular speeds may lower the total optical output power and, subsequently, the wall-plug power in the light source by a factor of 33. The light source may include a laser and an optical amplifier.

FIG. 9D illustrates a graph representation 940 showing the results of the experimental demonstration of a MOSCAP microring modulator spectra at different voltage levels and using normalized transmission, measured in dB, and wavelength, measured in nm, as the variables. The graph representation 940 further show static and dynamic extinction ratios at 28 Gb/s, which is also shown via diagram 942 of the 28 Gb/s eye diagram.

### Footprint-Energy Efficiency.

The footprint-energy efficiency [(MAC/J) (MAC/s/mm²)], defined as the product of the workload energy efficiency (MAC/J) and the throughput per footprint area (MAC/s/mm²), is used as the representative expression of measurement or figure of merit (FOM) of a TONN-MW. TABLE 2 compares the synapses per neuron (i.e., scale of the ANN), workload energy efficiency, and footprint-energy efficiency among different ANN hardware technologies, including analog electronics, digital electronics, and photonics. The scale of the photonics is set as 1024 in order to compete with the electrical ANNs. Since 1024×1024 integrated conventional ONNs are impractical, TONN architecture is assumed for all the photonic technologies.

The energy consumption of the photonic TONNs under static operation mainly consists of five parts: laser wall-plug power, microring modulator power, MZI mesh power, microring add-drop filter power, and PD receiver power. The MOSCAP platform is assumed to be with QD comb lasers, MOSCAP microring modulators, MOSCAP MZIs, and Si—Ge APDs. The silicon photonics (SiPh) and phase-change material (PCM) platform are assumed to be with distributed-feedback (DFB) lasers, silicon photonic microring modulators, SiPh (or PCM) MZIs, and Ge PIN PDs.

For the heterogeneous III-V-on-silicon MOSCAP platform, the laser wall-plug power is decided by the PD sensitivity (SENS_{PD}), the power margin (Power_margin), the total optical insertion loss (ILₜₒₜₐₗ), and the wall-plug efficiency (η) by P_{Laser}=10^{(SENS}_{PD}^{+Power_margin+IL}ₜₒₜₐₗ)^{/10}/η. The energy stored in the MOSCAP microring modulator can be calculated by C(Vₚₚ)²/2, where C is the capacitance and Vₚₚ is the peak-to-peak voltage swing. Assuming a non-return-to-zero (NRZ) modulation pattern, the probability of charging of the MOSCAP modulator is 0.25. The driver power consumption is assumed to be equal to the modulator. Thus, the power consumption of the MOSCAP microring modulator can be calculated by P_{Modulator}=BC(Vₚₚ)²/4 where B is the modulation bandwidth. Using MOSCAP phase tuning, the static power consumption of MZI meshes and microring add-drop filters is estimated to be zero. The total number of multiply-accumulate (MAC) per second of an N×N TONN-MW is BN². For a 1024×1024 TONN-MW, as shown in FIG. 8A-8C, assuming B=10 GHz, the total power consumption per wavelength is calculated to be 15.79 W, which corresponds to 6.5×10¹⁴ MAC/J. With an estimated area of 165 mm², the computing throughput per unit area is calculated to be 6.4×10¹³ MAC/s/mm². Thus, the footprint-energy efficiency of a 1024×1024 TONN-MW is 4.1×10²⁸ (MAC/J) (MAC/s/mm²).

With the footprint-energy efficiency as the FOM, the MOSCAP TONN outperforms the digital electronics and most of the analog electronics technologies by a factor of 1.4×10⁴ and 5.1×10⁹, respectively. As shown in TABLE 2, the MOSCAP TONN architecture exhibits a 10× larger number of synapses per neuron and 15.8× higher FOM compared with analog flash memory technology. Compared with TONNs with the other photonic technologies, including SiPh and PCM, the MOSCAP TONN improves the footprint-energy efficiency by 290× due to the following reasons: (1) Heterogeneous integration of all the optical components eliminates the coupling loss between discrete chips, (2) MOSCAP MZIs and microring add-drop filters have negligible static phase tuning energy consumption, while SiPh technologies require power to maintain the phase tuning, and (3) High-sensitivity APD significantly reduces the required laser wall-plug power.

Overall, there are three advantages to the MOSCAP TONN architecture. First, large-scale ONNs without O/E/O conversions and intermediate memory are now realized, thus significantly improving energy efficiency and latency. Second, the MOSCAP TONN architecture enables scaling up to 1024×1024 and beyond with significantly fewer MZIs and cascaded stages of MZIs, which lead to a significantly more compact footprint, smaller optical loss budget, and more manageable control complexity. For instance, simulations show that the TONNs utilize 79× fewer MZIs and 5.2× fewer cascaded stages of MZIs than the conventional ONNs while maintaining a >95% accuracy for Modified National Institute of Standards and Technology (MNIST) handwritten digit classification tasks. Third, the footprint of the 1024×1024 MOSCAP TONN can be 27×6 mm² in a folded configuration. Thus, integrating the 1024×1024 TONN in a single photonic die is achievable, considering that the maximum field size of the deep ultraviolet (DUV) stepper is 27×22 mm². The total number of MZIs in the 1024×1024 MOSCAP TONN is 4.5× less than the Lighmatter's 64×64 chip. The packaging of photonic tensor cores, CMOS driver chips, and memory chips can be realized by three-dimensional (3D) co-package technology. Recently, several foundries (e.g., AIM Photonics) have started to provide SiPh interposer services that could co-package SiPh and electronic integrated circuits in a 3D stack using through Si via (TSV). The 3D co-package technology brings CMOS chips closer to the compute nodes (photonic TONN chips) so that the integration density and energy efficiency can be further increased.

In conclusion, a scalable, energy-efficient, and compact TONN architecture on the integrated III-V-on-silicon MOSCAP platform is described herein. Based on TT decomposition, the high-radix (e.g., 1024×1024) synaptic interconnections can be enabled by cascaded small-radix (e.g., 8×8) photonic tensor-train cores. The detailed TONN device architectures with single or multiple wavelengths are provided. Simulation experiments show that TONN-MW saves 79× MZIs and 5.2× cascaded stages of MZIs compared with conventional ONN while maintaining a >95% training accuracy for MNIST handwritten digit classification tasks. Furthermore, with footprint-energy efficiency as the figure of merit, the TONN-MW on the heterogeneous III-on-silicon MOSCAP platform outperforms the digital electronics and other photonic technologies by a factor of 1.4×10⁴ and 2.9×10², respectively. The TONN architecture points out the road map for the future physical implementation of ONNs scaling up to 1024 and beyond, with significantly reduced hardware requirements and ultra-high energy efficiency.

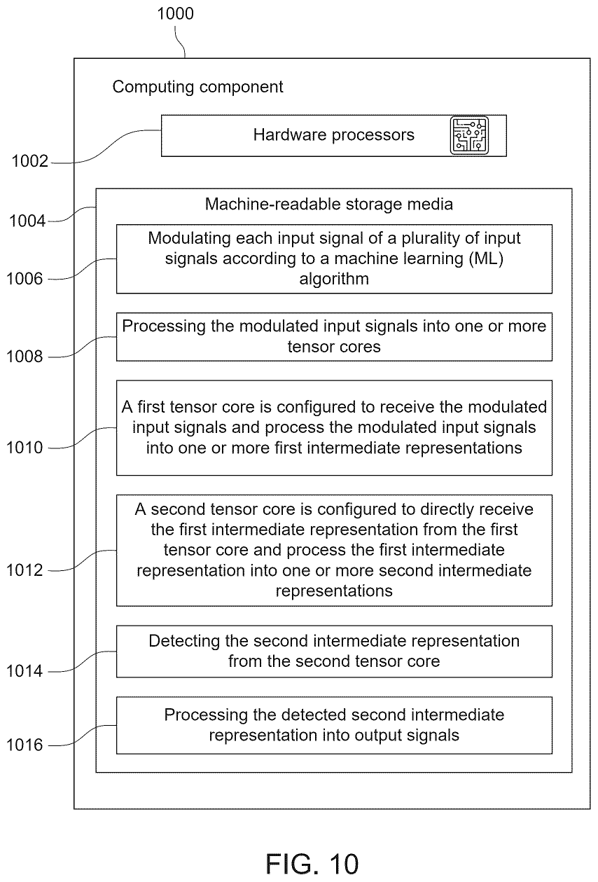

FIG. 10 illustrates a computing component 1000 that includes one or more hardware processors 1002 and machine-readable storage media 1004 storing a set of machine-readable/machine-executable instructions that, when executed, cause the hardware processor(s) 1002 to perform an illustrative method for implementing a tensorized optical neural network (TONN). It should be appreciated that there can be additional, fewer, or alternative steps performed in similar or alternative orders, or in parallel, within the scope of the various examples discussed herein unless otherwise stated. The computing component 1000 may be implemented as the TONN-SW 400 of FIG. 4, the TONN-MW 500 of FIG. 5A and FIG. 5B, and the device architecture 800 of FIG. 8A-8C. FIG. 10 summarizes and further elaborates on some aspects previously described.

At step 1006, the hardware processor(s) 1002 may execute machine-readable/machine-executable instructions stored in the machine-readable storage media 1004 to modulate each input signal of a plurality of input. A plurality of input signals may be received by a tensorized optical neural network (TONN). The input signals may include optical signals. The optical signals may include signal light and reference light. After receiving the input signals, the TONN may modulate each input signal according to a machine learning (ML) algorithm. Modulating each input signal may include performing wavelength division multiplexing (WDM) on each input signal with one or more input wavelengths using one or more modulator arrays. The one or more input wavelengths may be associated with one or more optical lights. Each input wavelength may be a different color of optical light.

At step 1008, the hardware processor(s) 1002 may execute machine-readable/machine-executable instructions stored in the machine-readable storage media 1004 to process the modulated input signals. After modulating each input signal that is received by the TONN, the modulated input signals may be processed into one or more tensor cores, including a first tensor core, a second tensor core, a third tensor core, and so forth. The number of tensor cores may vary according to the TONN. Each tensor core may comprise one or more Mach-Zehnder interferometer (MZI)-based processors. Each MZI-based processor may comprise one or more MZI meshes. Each MZI-based processor may further comprise two beam splitters and two phase shifters.

At step 1010, the hardware processor(s) 1002 may execute machine-readable/machine-executable instructions stored in the machine-readable storage media 1004 to process the modulated input signals into a first tensor core. The first tensor core may be configured to receive the modulated input signals. After receiving the modulated input signals, the first tensor core may then process the modulated input signals into one or more first intermediate representations of the input signals. The first tensor core may contain one or more first MZI-based processors and each first MZI-based processor may comprise one or more first MZI meshes. Processing the modulated input signals may include splitting the modulated input signals into groups of input signals. Each group of input signals may contain an equal amount of input signals. The number of groups may be equal to the number of first MZI meshes in the first tensor core. Each group of input signals may be sent through a different first MZI mesh.

By sending the input signals into the first MZI meshes of the first tensor core, the input signals may be processed by multiplying the input signals by one or more components in the first MZI meshes. The product of the processed input signals with the components of the first MZI meshes may be one or more first intermediate representations. The first intermediate representations may be modifications or conversions of the input signals. Such modifications of the input signals may include altering the values of the input signals. Such conversions of the input signals may include converting the input signals from optical signals to electrical signals. If more than one tensor core exists in the TONN, then proceed to Step 1012. If only one tensor core exists in the TONN, then proceed to Step 1014.

At step 1012, the hardware processor(s) 1002 may execute machine-readable/machine-executable instructions stored in the machine-readable storage media 1004 to process the first intermediate representations into a second tensor core. The second tensor core may be configured to receive the first intermediate representations of the input signals. After the first intermediate representations have been received, the first intermediate representations may be further processed through an optical passive cross-connect. The optical passive cross-connect may be used to switch or exchange the first intermediate representations between different optical paths. Switching or exchanging the first intermediate representations may generate updated first intermediate representations. The updated first intermediate representations may then be sent into the second tensor core to be processed.

After receiving the updated first intermediate representations, the second tensor core may then process the updated first intermediate representations into one or more second intermediate representations of the input signals. The second tensor core may contain one or more second MZI-based processors and each second MZI-based processor may comprise one or more second MZI meshes. The second tensor core may contain the same number of second MZI-based processors as the first tensor core with first MZI-based processors. The second tensor core may contain the same number of second MZI meshes as the first tensor core with first MZI meshes. The updated first intermediate representations may be split into groups of updated first intermediate representations. Each group of updated first intermediate representations may contain an equal amount of input signals. The number of groups may be the equal to the number of second MZI meshes in the second tensor core. Each group of updated first intermediate representations may corresponding to the respective group of input signals from the first tensor core. Each second MZI mesh of the second tensor core may receive a different group of the updated first intermediate representations.

By sending the updated first intermediate representations into the second MZI meshes of the second tensor core, the updated first intermediate representations may be processed by multiplying the updated first intermediate representations by one or more components in the second MZI meshes. The product of the processed updated first intermediate representations with the components of the second MZI meshes may be one or more second intermediate representations. The second intermediate representations may be modifications of the updated first intermediate representations, which such modifications may include altering the values of the updated first intermediate representations. The second intermediate representations may be conversions of the updated first intermediate representations, which such conversions may include converting the updated first intermediate representations from optical signals to electrical signals. Repeat Step 1012 for each additional tensor core in the TONN until all of the tensor cores have been processed through. Proceed to Step 1014 if no additional tensor cores exist in the TONN, and the second intermediate representations are the final processed input signals.

At step 1014, the hardware processor(s) 1002 may execute machine-readable/machine-executable instructions stored in the machine-readable storage media 1004 to detect the second intermediate representations from the second tensor core. The TONN may detect the second intermediate representations from the second tensor core when the second intermediate representations are the final processed input signals. The second intermediate representations become the final processed input signals after the input signals have been processed through the last tensor core in the TONN. The TONN may contain one or more tensor cores for the input signals to be processed through. The number of tensor cores may vary according to the TONN.

At step 1016, the hardware processor(s) 1002 may execute machine-readable/machine-executable instructions stored in the machine-readable storage media 1004 to process the detected second intermediate representations into output signals. After the second intermediate representations have been detected to be the final processed input signals, the detected second intermediate representations may be processed into output signals. Processing the detected second intermediate representations may include performing wavelength division multiplexing (WDM) on each of the detected second intermediate representations with the one or more input wavelengths using one or more detector arrays. The one or more input wavelengths may be associated with one or more optical lights. Each input wavelength may be a different color of optical light. The output signals may be the final modifications or conversions of the input signals. Such final modifications of the input signals may include altering the values of the input signals. Such final conversions of the input signals may include converting the input signals from optical signals to electrical signals. The value of the output signals may vary according to the TONN. The output signals may also be analyzed versions of the input signals. Many variations are possible.

Subsequently, the hardware processor(s) 1002 may receive subsequent input signals and repeat the aforementioned steps for each of the subsequent input signals received, until input signals are no longer being received by the TONN.

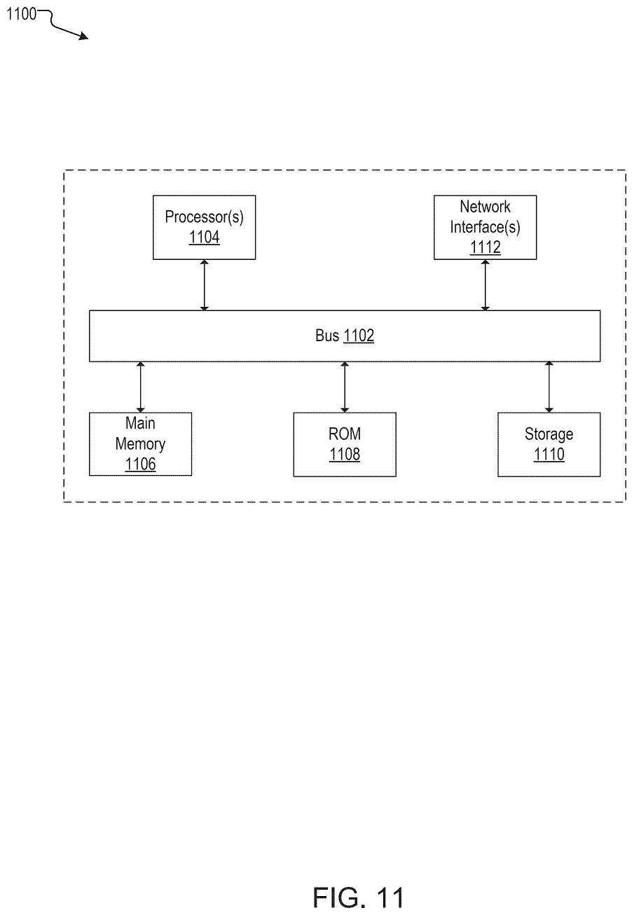

FIG. 11 illustrates a block diagram of an example computer system in which various examples of the present disclosure may be implemented. The computer system 1100 can include a bus 1102 or other communication mechanism for communicating information, one or more hardware processors 1104 coupled with the bus 1102 for processing information. The hardware processor(s) 1104 may be, for example, one or more general purpose microprocessors. The computer system 1100 may be an example of a client-server communication or similar device.

The computer system 1100 can also include a main memory 1106, such as a random access memory (RAM), cache and/or other dynamic storage devices, coupled to the bus 1102 for storing information and instructions to be executed by the hardware processor(s) 1104. The main memory 1106 may also be used for storing temporary variables or other intermediate information during execution of instructions by the hardware processor(s) 1104. Such instructions, when stored in a storage media accessible to the hardware processor(s) 1104, render the computer system 1100 into a special-purpose machine that can be customized to perform the operations specified in the instructions.

The computer system 1100 can further include a read only memory (ROM) 1108 or other static storage device coupled to the bus 1102 for storing static information and instructions for the hardware processor(s) 1104. A storage device 1110, such as a magnetic disk, optical disk, or USB thumb drive (Flash drive), etc., can be provided and coupled to the bus 1102 for storing information and instructions.

Computer system 1100 can further include at least one network interface 1112, such as a network interface controller module (NIC), network adapter, or the like, or a combination thereof, coupled to the bus 1102 for connecting the computer system 1100 to at least one network.

In general, the word “component,” “modules,” “engine,” “system,” “database,” and the like, as used herein, can refer to logic embodied in hardware or firmware, or to a collection of software instructions, possibly having entry and exit points, written in a programming language, such as, for example, Java, C or C++. A software component or module may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices, such as the computing system 1100, may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of an executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 1100 may implement the techniques or technology described herein using customized hard-wired logic, one or more ASICs or FPGAs, firmware and/or program logic which in combination with the computer system 1100 that causes or programs the computer system 1100 to be a special-purpose machine. According to one or more examples, the techniques described herein are performed by the computer system 1100 in response to the hardware processor(s) 1104 executing one or more sequences of one or more instructions contained in the main memory 1106. Such instructions may be read into the main memory 1106 from another storage medium, such as the storage device 1110. Execution of the sequences of instructions contained in the main memory 1106 can cause the hardware processor(s) 1104 to perform process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. The non-volatile media can include, for example, optical or magnetic disks, such as the storage device 1110. The volatile media can include dynamic memory, such as the main memory 1106. Common forms of the non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

The non-transitory media is distinct from but may be used in conjunction with transmission media. The transmission media can participate in transferring information between the non-transitory media. For example, the transmission media can include coaxial cables, copper wire and fiber optics, including the wires that comprise the bus 1102. The transmission media can also take a form of acoustic or light waves, such as those generated during radio-wave and infra-red data communications.

Embodiments of the present technology may be described herein with reference to flowchart illustrations of methods and systems according to embodiments of the technology, and/or procedures, algorithms, steps, operations, formulae, or other computational depictions, which may also be implemented as computer program products. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure(s) algorithm(s), step(s), operation(s), formula (e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored local to the device in non-transitory media, or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, that the terms processor, hardware processor, computer processor, central processing unit (CPU), and computer are used synonymously to denote a device capable of executing the instructions and communicating with input/output interfaces and/or peripheral devices, and that the terms processor, hardware processor, computer processor, CPU, and computer are intended to encompass single or multiple devices, single core and multicore devices, and variations thereof.

From the description herein, it will be appreciated that the present disclosure encompasses multiple implementations of the technology which include, but are not limited to, the following:

A method for implementing a tensorized optical neural network comprising: (a) modulating each input signal of a plurality of input signals according to a machine learning (ML) algorithm; (b) processing the modulated input signals into one or more tensor cores, wherein: (b)(i) a first tensor core is configured to receive the modulated input signals and process the modulated input signals into one or more first intermediate representations; and (b)(ii) a second tensor core is configured to directly receive the first intermediate representations from the first tensor core and process the first intermediate representations into one or more second intermediate representations; (c) detecting the second intermediate representations from the second tensor core; and (d) processing the detected second intermediate representations into output signals.

A computing system comprising: (a) one or more processors; and (b) a memory storing instructions that, when executed by the one or more processors, cause the one or more processors to: (b)(i) modulate each input signal of a plurality of input signals according to a machine learning (ML) algorithm; (b)(ii) process the modulated input signals into one or more tensor cores, wherein: (b)(ii)(1) a first tensor core is configured to receive the modulated input signals and process the modulated input signals into one or more first intermediate representations; and (b)(ii)(2) a second tensor core is configured to directly receive the first intermediate representations from the first tensor core and process the first intermediate representations into one or more second intermediate representations; (b)(iii) detect the second intermediate representations from the second tensor core; and (b)(iv) process the detected second intermediate representations into output signals.

A non-transitory storage medium storing instructions that, when executed by at least one processor of a computing system, cause the computing system to perform a method comprising: (a) modulating each input signal of a plurality of input signals according to a machine learning (ML) algorithm; (b) processing the modulated input signals into one or more tensor cores, wherein: (b)(i) a first tensor core is configured to receive the modulated input signals and process the modulated input signals into one or more first intermediate representations; and (b)(ii) a second tensor core is configured to directly receive the first intermediate representations from the first tensor core and process the first intermediate representations into one or more second intermediate representations; (c) detecting the second intermediate representations from the second tensor core; and (d) processing the detected second intermediate representations into output signals.

The method, computing system or non-transitory storage medium of any preceding implementation,

The method, computing system or non-transitory storage medium of any preceding implementation, wherein the input signals are optical signals comprising signal light and reference light.

The method, computing system or non-transitory storage medium of any preceding implementation, wherein the modulating each input signal includes performing wavelength division multiplexing (WDM) on each input signal with one or more input wavelengths using one or more modulator arrays.

The method, computing system or non-transitory storage medium of any preceding implementation, wherein the one or more input wavelengths are associated with one or more optical lights and each input wavelength is a different color of optical light.

The method, computing system or non-transitory storage medium of any preceding implementation, wherein utilization of the wavelength domain in the tensorized optical neural network significantly reduces the complexity of the tensorized optical neural network.

The method, computing system or non-transitory storage medium of any preceding implementation, wherein the processing the detected second intermediate representation comprises performing WDM on each second intermediate representation with the one or more input wavelengths using one or more detector arrays.

The method, computing system or non-transitory storage medium of any preceding implementation, wherein each tensor core comprises one or more Mach-Zehnder interferometer (MZI)-based processors and each MZI-based processor comprises one or more meshes.

The method, computing system or non-transitory storage medium of any preceding implementation, wherein each MZI-based processor comprises two beam splitters and two phase shifters.

The method, computing system or non-transitory storage medium of any preceding implementation, wherein the output signals comprise data conversions of the input signals.

As used herein, term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing a group of elements, indicates that at least one of these group elements is present, which includes any possible combination of the listed elements as applicable.

References in this disclosure referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system or method.

As used herein, the term “set” refers to a collection of one or more objects. Thus, for example, a set of objects can include a single object or multiple objects.

Relational terms such as first and second, top and bottom, upper and lower, left and right, and the like may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element.

As used herein, the terms “approximately”, “approximate”, “substantially”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way, but may also be configured in ways that are not listed.

Benefits, advantages, solutions to problems, and any element(s) that may cause any benefit, advantage, or solution to occur or become more pronounced are not to be construed as a critical, required, or essential features or elements of the technology describes herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after that application is filed. Accordingly the reader should consult the application as filed for the original content of the disclosure. Any deletion of content of the disclosure should not be construed as a disclaimer, forfeiture or dedication to the public of any subject matter of the application as originally filed.

The following claims are hereby incorporated into the disclosure, with each claim standing on its own as a separately claimed subject matter.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

TABLE 1

| | | Total Number of |
|---|---|---|
| | Total Number | Cascaded Stages |
| | of MZIs | of MZIs |
| Conventional ONN | N(N − 1)/2 | N |
| TONN-SW | dRN (RN^{1/d} − 1) | dRN^{1/d} |
| TONN-MW | dRN^{1/2} (RN^{1/d} − 1) | dRN^{1/d} |

TABLE 2

| | | | | Figure of Merit |
|---|---|---|---|---|
| | | Synapses | | (MAC/J |
| Category | Technology | per Neuron | MAC/J | MAC/s/mm²) |
| Analog | NeuroGrid | 4096 | 9 × 10⁹ | 8 × 10¹⁵ |
| Electronics | HiCANN | 224 | 4.7 × 10⁹ | 2 × 10¹⁷ |
| | TrueNorth | 256 | 3.3 × 10¹² | >8 × 10¹⁸ |
| | Flash memory | 100 | 1.4 × 10¹⁴ | 2.6 × 10²⁷ |
| Digital | NVIDIA Volta | 4096 | 2 × 10¹¹ | 2 × 10²² |
| Electronics | Google TPU | Multiple | 5.8 × 10¹¹ | 9.5 × 10²² |
| | | of 128 | | |
| | Graphcore | 1216 | 2 × 10¹² | 7 × 10²³ |
| | Memristor | 256 | 6.9 × 10¹² | 6.9 × 10²³ |
| | crossbar | | | |
| | Groq | 640 | 3.3 × 10¹² | 3 × 10²⁴ |
| Photonics | SiPh TONN | 1024 | 7.3 × 10¹¹ | 9.8 × 10²⁵ |
| | PCM TONN | 1024 | 1.1 × 10¹² | 1.4 x 10²⁶ |
| | MOSCAP | 1024 | 6.5 x 10¹⁴ | 4.1 × 10²⁸ |
| | TONN | | | |

What is claimed is:

1. A method for implementing a tensorized optical neural network comprising:
modulating each input signal of a plurality of input signals according to a machine learning (ML) algorithm;
processing the modulated input signals into one or more tensor cores, wherein:
a first tensor core is configured to receive the modulated input signals and process the modulated input signals into one or more first intermediate representations; and
a second tensor core is configured to directly receive the first intermediate representations from the first tensor core and process the first intermediate representations into one or more second intermediate representations;
detecting the second intermediate representations from the second tensor core; and
processing the detected second intermediate representations into output signals.

2. The method of claim 1, wherein the input signals are optical signals comprising signal light and reference light.

3. The method of claim 1, wherein the modulating each input signal includes performing wavelength division multiplexing (WDM) on each input signal with one or more input wavelengths using one or more modulator arrays.

4. The method of claim 3, wherein the one or more input wavelengths are associated with one or more optical lights and each input wavelength is a different color of optical light.

5. The method of claim 1, wherein utilization of a wavelength domain in the tensorized optical neural network significantly reduces complexity of the tensorized optical neural network.

6. The method of claim 1, wherein the processing the detected second intermediate representation comprises performing WDM on each second intermediate representation with one or more input wavelengths using one or more detector arrays.

7. The method of claim 1, wherein each tensor core comprises one or more Mach-Zehnder interferometer (MZI)-based processors and each MZI-based processor comprises one or more meshes.

8. The method of claim 7, wherein each MZI-based processor comprises two beam splitters and two phase shifters.

9. The method of claim 1, wherein the output signals comprise data conversions of the input signals.

10. A computing system comprising:
one or more processors; and
a memory storing instructions that, when executed by the one or more processors, cause the one or more processors to:
modulate each input signal of a plurality of input signals according to a machine learning (ML) algorithm;
process the modulated input signals into one or more tensor cores, wherein:
a first tensor core is configured to receive the modulated input signals and process the modulated input signals into one or more first intermediate representations; and
a second tensor core is configured to directly receive the first intermediate representations from the first tensor core and process the first intermediate representations into one or more second intermediate representations;
detect the second intermediate representations from the second tensor core; and
process the detected second intermediate representations into output signals.

11. The computing system of claim 10, wherein the input signals are optical signals comprising signal light and reference light.

12. The computing system of claim 10, wherein the modulate each input signal includes performing wavelength division multiplexing (WDM) on each input signal with one or more input wavelengths using one or more modulator arrays.

13. The computing system of claim 12, wherein the one or more input wavelengths are associated with one or more optical lights and each input wavelength is a different color of optical light.

14. The computing system of claim 10, wherein the processing the detected second intermediate representation comprises performing WDM on each second intermediate representation with the one or more input wavelengths using one or more detector arrays.

15. The computing system of claim 10, wherein each tensor core comprises one or more Mach-Zehnder interferometer (MZI)-based processors and each MZI-based processor comprises one or more meshes.

16. The computing system of claim 15, wherein each MZI-based processor comprises two beam splitters and two phase shifters.

17. The computing system of claim 10, wherein the output signals comprise data conversions of the input signals.

18. A non-transitory storage medium storing instructions that, when executed by at least one processor of a computing system, cause the computing system to perform a method comprising:
modulating each input signal of a plurality of input signals according to a machine learning (ML) algorithm;
processing the modulated input signals into one or more tensor cores, wherein:
a first tensor core is configured to receive the modulated input signals and process the modulated input signals into one or more first intermediate representations; and
a second tensor core is configured to directly receive the first intermediate representations from the first tensor core and process the first intermediate representations into one or more second intermediate representations;
detecting the second intermediate representations from the second tensor core; and
processing the detected second intermediate representations into output signals.

19. The non-transitory storage medium of claim 18, wherein the modulating of each input signal includes performing wavelength division multiplexing (WDM) on each input signal with one or more input wavelengths using one or more modulator arrays.

20. The non-transitory storage medium of claim 18, wherein the processing the detected second intermediate representation comprises performing WDM on each second intermediate representation with one or more input wavelengths using one or more detector arrays.

21. The non-transitory storage medium of claim 17, wherein each tensor core comprises one or more Mach-Zehnder interferometer (MZI)-based processors and each MZI-based processor comprises one or more meshes.
